(19) United States
(12) Patent Application Publication
(10) Pub. No.: US 2014/0356545 A1
(43) Pub. Date: Dec. 4, 2014

(54) METHOD AND APPARATUS FOR ELECTROSTATIC PAINTING USING OXYGEN-ENRICHED CARRIER FLUID

(71) Applicant: EUROSIDER S.A.S. di Milli Ottavio & C., GROSSETO (IT)

(72) Inventor: Ottavio MILLI, GROSSETO (IT)

(73) Assignee: EUROSIDER S.A.S. di Milli Ottavio & C., GROSSETO (IT)

(21) Appl. No.: 14/253,295

(22) Filed: Apr. 15, 2014

(30) Foreign Application Priority Data
Jun. 3, 2013 (IT) FI2013A000132

(51) Int. Cl. B05D 1/04

(52) U.S. Cl. CPC B05D 1/04
USPC 427/460; 118/621

(57) ABSTRACT

A method and an apparatus for industrial and professional electrostatic painting, in accordance with ionization parameters predetermined according to the type of material to be painted and implemented using an electrostatically charged pressurized carrier fluid (whether positively charged, negatively charged, or in the neutral plasma state) combined to a flow of atomized liquid paint or powder paint, including a step of oxygen-enrichment of the paint-carrier fluid in order to obtain a higher degree of electrostatic grip of the carrier fluid.

### SECTOR OF THE INVENTION

The present invention finds application in the industrial and professional painting sector implemented by means of plants that use electrostatically charged paint-carrier flows in order to optimize the yield of the process.

It is in fact known that static electricity is a physical phenomenon that, by involving all the surfaces and causing a transfer of electrons from one atom to another of each material, conditions the results of painting processes.

The level of electrostatic charge of a surface depends upon various factors, such as the material in question and its physical and electrical properties, the temperature and humidity of the surrounding environment, etc.

The table appearing below highlights how different materials of the substrates to be painted have a distinct tribo-electric characteristic, hence reacting in a different way to known painting processes, in which a single fixed parameter of ionization of the paint conveyed onto the surface to be painted is used.

Thus constituting a technical problem to be solved, in the field in question, is both increasing the electrostatic grip of the paint-carrier flow and adapting the ionizing charge of said fluid according to the different type of materials that are to be painted.

In order to solve the aforesaid technical problems, the present invention regards a method and an apparatus for electrostatic-painting systems with liquid or powder paint, which exploits the use of a carrier fluid constituted by simple compressed air, or preferably modified air continuously obtained from compressed air during painting and which envisages sending the atomized liquid paint or powder paint electrostatically charged prior to being conveyed onto the substrate to be painted.

In greater detail, in the present description it is to be understood that the air is “modified” in the sense that, starting from the natural composition of ambient air, it is deprived of the undesirable substances present in the natural composition, thus obtaining a carrier fluid in the form of a mixture made up exclusively of nitrogen, oxygen, and argon in the preferred percentages so as to achieve an increase in electrostatic grip useful for better ionization of said carrier fluid.

As preferred solution, said mixture is a mixture rich in nitrogen that is obtained, alternatively, via hollow-fibre osmotic-separation membrane means or else via pressure-swing absorption (PSA).

In this connection, it is to be recalled that natural ambient air, according to the reference tables of the U.S. International Standard Atmosphere, is made up as appears in the table below.

TABLE A
Ambient Air Specification (U.S. International
Standard Atmosphere)

| Substance | Symbol | Value | Unit |
|---|---|---|---|
| Nitrogen | N₂ | 78.080 | vol. % |
| Oxygen | O₂ | 20.944 | vol. % |
| Argon | Ar | 0.934 | vol. % |
| Carbon Dioxide | CO₂ | 350/360 | ppmV |
| Neon | Ne | 16.1 | ppmV |
| Helium | He | 4.6 | ppmV |
| Kripton | Kr | 1.08 | ppmV |
| Xenon | Xe | 0.08 | ppmV |
| Methane | CH₄ | 2.2 | ppmV |
| Hydrogen | H₂ | 0.5 | ppmV |
| Nitrogen Protoxide | N₂O | 0.3 | ppmV |
| Carbon Monoxide | CO | 0.2 | ppmV |
| Ozone | O₃ | 0.04 | ppmV |
| Ammonia | NH₃ | 4 | ppbV |
| Sulphur Dioxide | SOₓ | 1.7 | ppbV |
| Nitrogen Oxide | NOₓ | 1.5 | ppbV |
| Hydrogen Sulphide | H₂S | 0.05 | ppbV |
| Total Organics (other than Methane) | | <10 | ppmV |
| Other Acid Gases (HCl, etc.) | | <0.1 | ppmV |
| Dust | | 5 | mg/Nm² |
| Water | H₂O | <65 | g/Nm³ |

### PRIOR ART

Electrostatic-painting systems are known that use compressed air as carrier fluid, which involve all the problems, which are well known in the sector, determined by the presence of particles of hydrocarbons and humidity, which are not conducive to achieving the best results in painting processes.

Likewise known are electrostatic-painting systems that, to overcome the problems referred to above, use, as carrier fluid, modified air, and in particular modified air rich in nitrogen.

An example of the above apparatus is described in the patent application No. WO2009056950 filed in the name of the present applicant.

As is known, these systems benefit from the advantageous characteristics of the nitrogen-modified air in so far as it is inert and capable of bestowing on the flow of carrier fluid a higher speed of transport, as well as enabling a considerable saving of paint.

However, it has been found that, as the conditions of use and the type of substrate to be painted (metal, plastic, more or less complex shapes) vary, the use of modified air, in particular if rich in nitrogen, is not always optimal for the purpose of obtaining the preferred intensity of electrostatic charge. In fact, nitrogen is not able to attract electrostatic charges in so far as it is an inert gas, unlike oxygen, which has a good electrostatic gripping capacity and is a molecule present in air in a far higher percentage than is argon, which in turn presents electrostatic attractivity.

### OBJECT OF THE INVENTION

A first object of the present invention is thus to provide a method and an apparatus for electrostatic painting that will be free from the aforesaid drawbacks of the known systems described above.

### SUMMARY OF THE INVENTION

The above and further purposes have been achieved with a method and an apparatus for electrostatic painting that will be able in an effective and immediate way to modify the intensity and the sign of the electrostatic charge, parameterizing the latter according to the painting conditions and/or to the different type of the substrate to be painted.

A first advantage of the invention lies in the fact that it is possible to set the apparatus in the best painting conditions during use, without any structural modifications or interruptions of the working process, irrespective of the substrate to be painted.

### LIST OF THE DRAWINGS

The above and further advantages will be better understood by any person skilled in the branch from the ensuing description and from the annexed drawings, which are provided by way of non-limiting example and in which:

FIG. 1 is a schematic illustration of an apparatus according to the invention; and

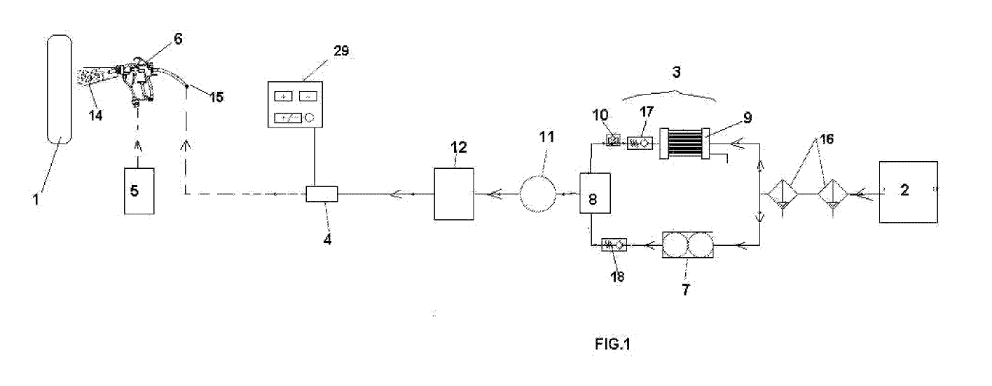

FIG. 2 shows a table of the tribo-electric characteristics of the materials.

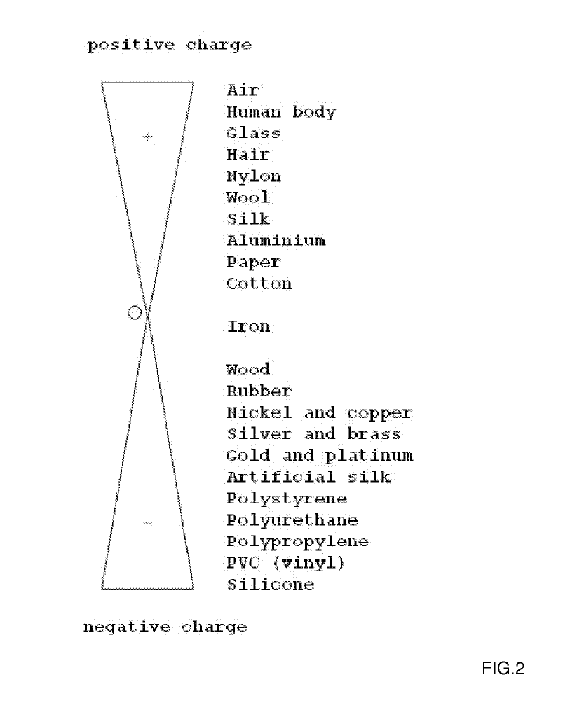

### DETAILED DESCRIPTION

With reference to the drawings, described hereinafter is an apparatus for painting a substrate 1 using a dispenser 6, of a type in itself conventional, which sends onto the substrate a spray fan 14 made up of a carrier fluid coming from a duct 15 and liquid or powder paint coming from a container 5.

The carrier fluid is supplied by a source 2 of compressed air obtained by taking in natural ambient air, possibly filtered by means of filters 16, and introduced into a unit 3 that can be regulated for modifying the composition by separating residual substances from the air and depriving the air of residual substances to obtain a pressurized flow of a mixture of modified air rich in nitrogen, oxygen, and argon.

Preferably, the unit 3 comprises a hollow-fibre membrane nitrogen separator 9 provided at outlet with a non-return valve 17 and a flow regulator 10.

Advantageously, via the flow regulator 10 it is possible to vary the percentage of residual nitrogen and oxygen of the modified air to obtain, preferably, a flow of modified air comprising a percentage of nitrogen ranging between 78% and 99% and oxygen ranging between 21% and 40%.

Moreover provided downstream of the unit 3 is an ionizing unit 4 for electrostatically charging the flow of modified air and obtaining a flow of pressurized carrier fluid positively charged, negatively charged, or in the neutral plasma state. For this purpose, the ionizing unit 4 is controlled by a control panel 29, via which the operator can select the positive or negative sign, or the neutral state, of the charges induced by the ionizing unit in the flow of carrier fluid.

According to the invention, the apparatus further comprises a unit 7 that can be regulated for enriching the flow of modified air supplied by the unit 3 with an additional flow of oxygen with a purity of between 70% and 98%.

Preferably, the regulatable unit 7 comprises a PSA molecular-filter separator supplied by the compressed-air source 2 itself and provided at outlet with a non-return valve 18.

Thanks to the invention, the dispenser 6 is then supplied by a carrier fluid constituted by a flow of modified air free from dust, oil, and other residual substances removed by the separation unit 3 and by the flow of oxygen regulated by the unit 7.

With this solution the percentage of oxygen present in the carrier fluid can be regulated in an optimal way by parameterizing it according to the painting conditions and/or to the type of substrate to be painted.

Advantageously, since the molecules of pure oxygen obtained by means of separation with a ceramic-zeolite and/or lithium-zeolite PSA module have a high ionizing capacity, by increasing or reducing the percentage of oxygen it is possible to obtain a greater capacity of attraction of electrostatic charge of the flow of carrier fluid, thus optimizing the efficiency of transfer of the atomized particles of paint and a better penetration of the electrostatically charged pulverized particles into the substrate.

Thanks to the invention, by increasing the percentage of oxygen of the carrier fluid, atomization of the liquid paint and/or its pulverization (in the case of use of powder paint) will hence present a better transfer efficiency owing to the higher intensity of the electrostatic charge. Advantageously, the higher intensity of electrostatic charge renders possible a better penetration of the charged particles, eliminating the Faraday-cage effect, which occurs above all in substrates with complex geometries and which, in known painting processes, prevents the particles of paint or powder from reaching uniformly all the corners and recesses or the points to be painted.

A further advantage lies in the marked reduction in the effect of bouncing off of the particles of paint as a result of the electrostatic grip referred to more than once above.

By way of example, the substrate 1 may be a metal, plastic, or wooden substrate, having a more or less complex shape and thus requiring a positive, negative, or neutral electrostatic charge of varying intensity.

A further advantage of the invention hence lies in the possibility of obtaining, by means of pre-determined settings, conditions of ionization of the fluid parameterized according to the electrostatic nature of the surface to be painted.

For this purpose, the present invention envisages management of the painting apparatus by means of a control and mixing unit 8 that can be governed from an external panel by the operator and is connected both to the separation unit 3 (to obtain a desired percentage of nitrogen and oxygen of the modified air) and to the oxygen-enrichment unit 7 (to obtain a desired amount of additional oxygen).

In the embodiment described, the two flows of modified air and of additional oxygen converge in a control and mixing unit 8, which gives out into a pressurized reservoir 11 for storage of the carrier fluid.

From the reservoir 11 the carrier fluid flows through a heat-conditioning assembly 12 that is able to condition the temperature thereof at a preferred value, which is adjustable and constant, comprised between −20° C. and +100° C.

In a preferred example of exploitment of the invention, it has been found that a flow of carrier fluid negatively charge at a temperature of around 8° C. and a pressure of approximately 0.5 Bar allows to obtain a very smooth and uniform coating of metal supports having an even complex shape.

In different embodiments, the heat-conditioner 12 may comprise both electrical heating elements, for example resistances, and cooling modules, for example plate chillers.

The present invention has been described according to preferred embodiments, but equivalent variants may be devised, without departing from the sphere of protection of the invention.

1. A method for electrostatic painting of a substrate (1) by means of an apparatus comprising:
a source (2) of compressed air obtained by taking in ambient air;
an ionizing unit (4) for electrostatically charging said flow of compressed air and obtaining a flow of positively or negatively charged pressurized carrier fluid;
a source (5) of liquid or powder paint; and
a dispenser (6) for sending onto said substrate a mixture of said carrier fluid and atomized paint,
said method being characterized in that it comprises a step of enrichment of said flow of compressed air with an additional adjustable flow of oxygen.

2. The method according to claim 1, comprising a step of continuous modification of the composition of said compressed air by separating residual substances from the air and depriving the air of said residual substances to obtain a pressurized flow of modified air rich in nitrogen, oxygen, and argon.

3. The method according to claim 1, wherein said additional flow of oxygen is obtained by continuous separation starting from a flow of compressed natural air.

4. The method according to claim 1, wherein said additional flow of oxygen is obtained by at least one PSA (pressure-swing absorption) molecular-sieve separation unit.

5. The method according to claim 1, wherein said ionizing unit (4) is pre-arranged for electrostatically charging said flow of compressed air and obtaining a flow of pressurized carrier fluid whether positively charged or negatively charged or in the neutral plasma state.

6. An apparatus for electrostatic painting of a substrate (1), comprising:
a source (2) of compressed air obtained by taking in natural ambient air;
an ionizing unit (4) for electrostatically charging said flow of compressed air and obtaining a flow of positively or negatively charged pressurized carrier fluid;
a source (5) of liquid or powder paint; and
a dispenser (6) for sending onto said substrate a mixture of said carrier fluid and atomized paint,
said apparatus being characterized in that it comprises a second unit (7) that can be regulated for enriching said flow of compressed air with an additional flow of oxygen.

7. The apparatus according to claim 6, comprising a unit (3) that can be regulated for modifying the composition of said compressed natural air, continuously obtained by separating residual substances from the air and depriving the air of residual substances in order to produce a pressurized flow of modified compressed air rich in nitrogen, oxygen, and argon.

8. The apparatus according to claim 6, wherein said unit (7) is a unit for separating oxygen from air operating continuously starting from a flow of compressed natural air.

9. The apparatus according to claim 6, comprising a unit (8) for controlling said first unit (3) and enabling mixing to obtain a desired percentage of nitrogen and oxygen of said flow of modified air and for regulating said second unit (7) to obtain a desired amount of additional oxygen.

10. The apparatus according to claim 6, wherein said first regulatable unit (3) comprises an osmotic-membrane hollow-fibre nitrogen separator (9) provided at outlet with a flow regulator (10).

11. The apparatus according to claim 6, wherein said second regulatable unit (7) comprises a PSA molecular-sieve separator.

12. The apparatus according to claim 6, comprising a pressurized reservoir (11) for storage of said carrier fluid.

13. The apparatus according to claim 6, comprising an assembly (12) for heat-conditioning of said flow of carrier fluid.

14. The apparatus according to claim 6, wherein said heat-conditioning assembly is capable of conditioning the temperature of said flow of carrier fluid between −20° C. and +100° C.

15. The apparatus according to claim 6, comprising a control panel (9) for selecting the positive or negative sign or the neutral state of the charges induced by the ionizing unit in the flow of carrier fluid.

16. The apparatus according to claim 6, comprising a mixer (13), in which said flow of modified air and said flow of additional oxygen converge and from which said flow of carrier fluid exits.
